(19) United States
(12) Patent Application Publication
(10) Pub. No.: US 2006/0048532 A1
(43) Pub. Date: Mar. 9, 2006

(54) Self propelled food & beverage receptacle

(76) Inventor: Kevin Beal, Austin, TX (US)

Correspondence Address: Robert L. Greeson;7th Floor, 900 Washington Avenue, P.O. Box 1470, Waco, TX, 77603-1470, US

(21) Appl. No.: 10/937,095

(22) Filed: Sep. 9, 2004

(51) Int. Cl. B60H 1/32; F25D 3/08

(52) U.S. Cl. 62/239; 62/457.7

(57) ABSTRACT

A self propelled food and beverage receptacle. This device has an insulated storage means, in combination with a driving mechanism. Said driving mechanism allows for differential speed, steering, and breaking. The present device is thought to be most beneficial in serving large crowds, where the stored cargo must be quickly and efficiently transported over relatively large distances. Particular embodiments are envisioned where a device operator may ride upon said receptacle, or merely guide said receptacle with very little effort.

### BACKGROUND OF THE INVENTION

1. Field of the Invention

The present invention generally relates to an improved food and beverage receptacle. More specifically, the present invention relates to an improved food and beverage receptacle where the receptacle servers as insulated storage, and the device is motorized. Particular embodiments are configured to provide transport of both the stored items and the device operator. As such, the device easily fulfills different tasks.

2. Background Information

Insulated food and beverage receptacles, commonly referred to as “ice chests,” are commonly carried or transported by simply hauling or dragging the chest. In order to alleviate the strain involved, and reduce the brute force required, some ice chests are equipped with wheels. Moreover, some ice chests have added appendages, including: cutting boards, drink holders, wheels and the like—all to make these chests more useful.

However, even the ice chests that are equipped with wheels are subject to constraints. As the load becomes heavier, and the receptacle more bulky, the usefulness of wheels alone decreases. These problems are exaggerated in the common situation where the ice chest must be rolled up a graded surface. Further, such limitations become apparent in the context of accommodating large gatherings of people. Particularly, extremely large quantities of ice, food, and beverages need be stored and transported during sporting events or similar gatherings of people.

Through a novel combination of components, Applicant's invention obviates several of the limitations associated with available ice chests. The present device is an ice chest integrated with a small lightweight motor. Such configuration allows the ice chest to serve both as a transportation vehicle for a driver and as an ice chest. With particular designs, a driver may ride on the device to a destination. Other designs allow for the driver to walk along the ice chest, directing it to a desired location, all the while guiding the device virtually with no effort.

Further, particular versions of the invention allow for a particularly compact, lightweight device, where the device may be manually maneuvered with ease. Also, such embodiments are particularly useful for transporting relatively small amounts of cargo.

### SUMMARY OF THE INVENTION

In view of the foregoing, it is an object of the present invention to provide a food and beverage receptacle configured to transport a person.

It is another object of the present invention to provide a food and beverage receptacle configured to propel the receptacle by it's own motorization, with or without a driver.

It is another object of the present invention to relatively light weight provide an food and beverage receptacle

It is another object of the present invention to provide a food and beverage receptacle to use a motorization source, such as a gasoline motor or electric motor.

It is another object of the present invention to provide a food and beverage receptacle having steering, braking, and throttle controls engaged with so the driver can control their related functions.

It is another object of the present invention to provide a food and beverage receptacle incorporating foot pegs which will allow the driver have a place to put their feet while riding.

It is another object of the present invention to provide a food and beverage receptacle incorporating foot pegs which are retractable or will fold up to make carrying the invention easier.

It is another object of the present invention to provide a food and beverage receptacle having one wheel.

It is another object of the present invention to provide a food and beverage receptacle having two wheels.

It is another object of the present invention to provide a food and beverage receptacle having three wheels.

It is another object of the present invention to provide a food and beverage receptacle having four wheels.

It is another object of the present invention to provide a food and beverage receptacle easily adapted to different sizes and types of motors.

It is another object of the present invention to provide a food and beverage receptacle easily adapted to different sizes and types of steering mechanisms.

It is another object of the present invention to provide a food and beverage receptacle conducive to easy, manual transport.

It is another object of the present invention to provide a food and beverage receptacle provide accessories or upgrades for the invention including a sidecar, a trailer, saddle bags, lights, a backrest, a cover, seat cushions, different design handlebars, different design foot pegs, white tires, off road suspension and four wheel drive.

It is another object of the present invention to provide a food and beverage receptacle having a telescoping handle to steer the invention.

It is another object of the present invention to provide a food and beverage receptacle having the steering handle pivot at the bottom so that the handle can be angled to make towing or pulling easier, in a single front wheel design.

### BRIEF DESCRIPTION OF THE DRAWINGS

FIG. 1 is a perspective view drawing of the receptacle with the preferred embodiment of the motorization of the present invention.

FIG. 2 is a perspective view drawing of the invention with the preferred mode of steering, braking mechanism(s), throttle control, and motor embodiment

FIG. 3 is a perspective view drawing showing the use of an electric motor and it's preferred embodiment within the invention.

FIG. 4 is a top view drawing of the invention showing the physical placement of the drive and steering components along with steering component internal bracing.

FIG. 5 is a side view showing the motor placement in the invention and the division wall, which separates the motor from the storage area.

FIG. 6 is a perspective view drawing showing the alternative front steering mechanism with 4 wheels instead of three.

FIG. 7 is a perspective view drawing showing another alternative front steering mechanism with 4 wheels instead of three.

FIG. 8 is a drawing showing another alternative front steering mechanism with 4 wheels instead of three. This steering design uses the foot rests as the steering mechanism whereby pressure from the respective foot turns the invention as the wheels and axle turn upon a center pivot.

FIG. 9 is a perspective view drawing showing the use of an electric motor and battery instead of a liquid or gas powered motor. This drawing also shows an alternate extension of the steering arm whereby the handle can also serve as a pulling mechanism.

### DETAILED DESCRIPTION OF THE PREFERRED EMBODIMENT

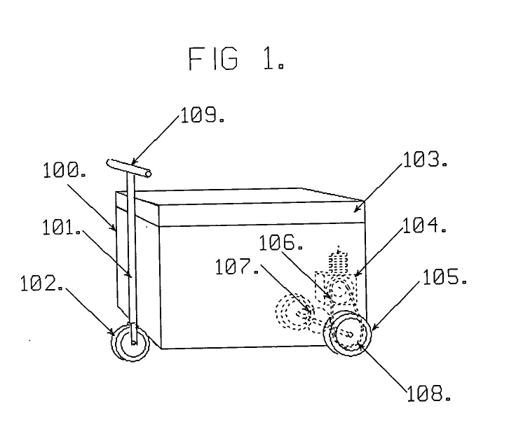

Referring generally to In FIG. 1, the device of the present invention is generally referred to by the numeral 10. In FIG. 1 insulated receptacle 100 is shown. Receptacle 100, in the preferred embodiment may be generally configured to allow access either from the top or the bottom.

Further, receptacle 100 is configured to receive and engage with motor means 104. The pivoting or removable lid is shown on top of receptacle 100 as 103. Receptacle 100 and other components are powered by motor 104, through a chain 106, to power the drive sprocket 108, which turns the tire 105. Braking is provided by pressure to a rear disk 107.

In the preferred embodiment, steering for the invention is through the front tire 102, as steering shaft 101 is turned by turning handle 109. Other useful embodiments are envisioned where lid 103 is configured to allow device 10 to be driven like an automobile, where the driver sits atop of lid 103.

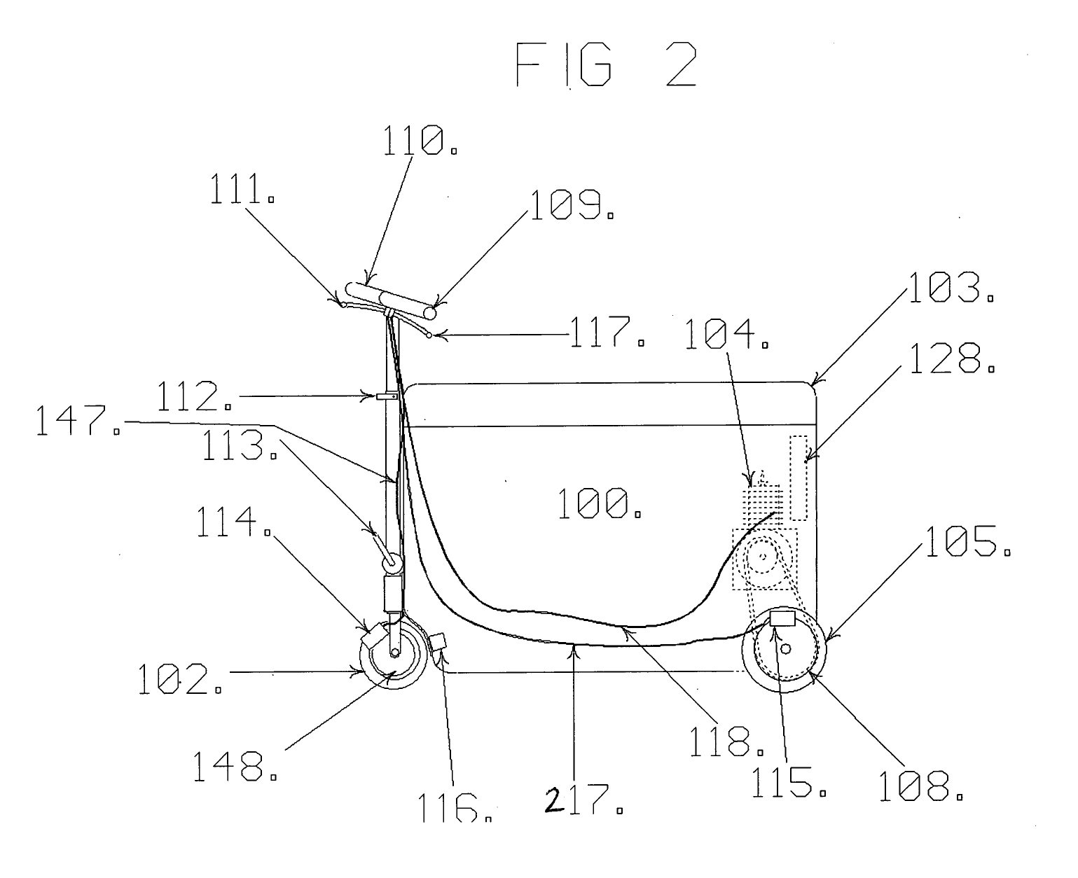

Referring primarily to FIG. 2 the throttle for the invention is controlled by the twisting of throttle tube 110. Tube 110 is mounted over upper steering control arm 109, which is attached cable 118, and extends to rear motor 104. Motor 104 then provides a regulated power supply to device 10.

Braking for device 10 is provided by the connection of one or more braking levers, 111 and 117, attached to front cable 147 and rear cable 217, respectively. Front cable 147 and rear cable 217 are connected to brake calipers 116 and 115 respectfully. The squeezing of levers 111 and 117 cause the calipers to close, providing pressure on the front disk 148 and the drive rear gear sprocket 108. Such action allows device 10 to be stopped.

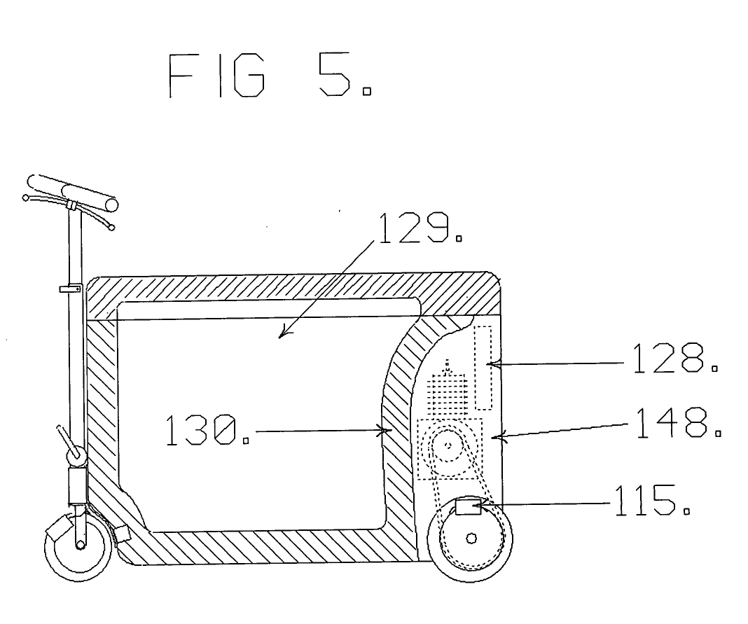

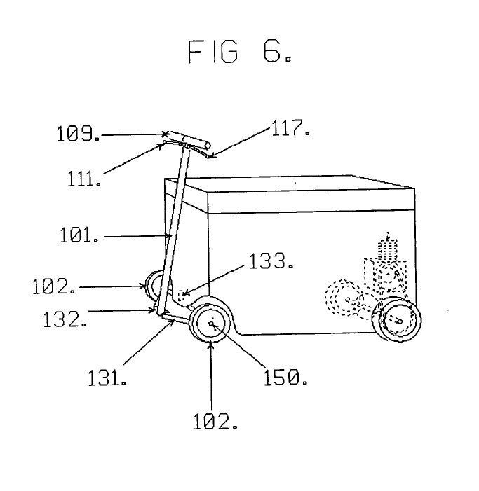

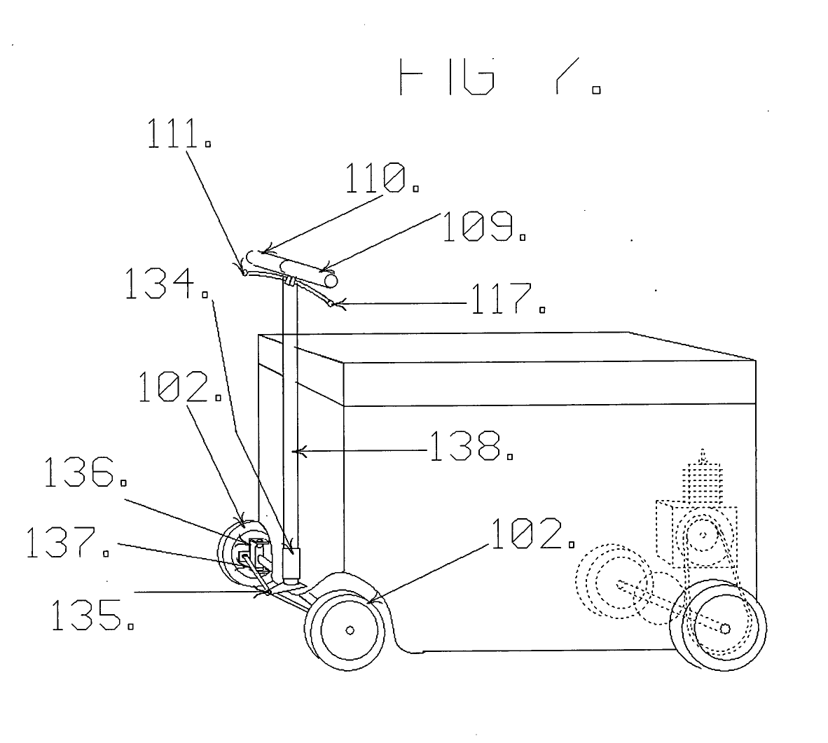

Referring now to FIG. 6 and FIG. 4, in the alternative, one of the two braking systems (front/back) may be eliminated so that only one lever/caliper/cable assembly is required. Retractable footrest 113 allows the driver a place to rest their feet while riding.

From FIG. 5 a fuel tank 128 is also incorporated into the design for the gasoline-powered embodiment of device 10.

Also shown in FIG. 2 is the motor means 104 which is mounted in the rear of the body 100 providing direct power through chain 106 to rear sprocket 108 which turns tire 105.

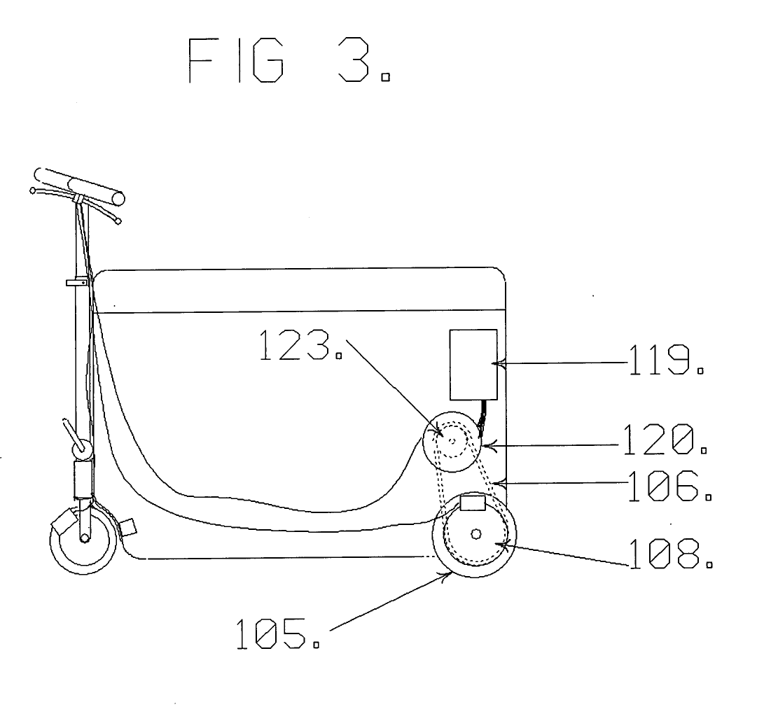

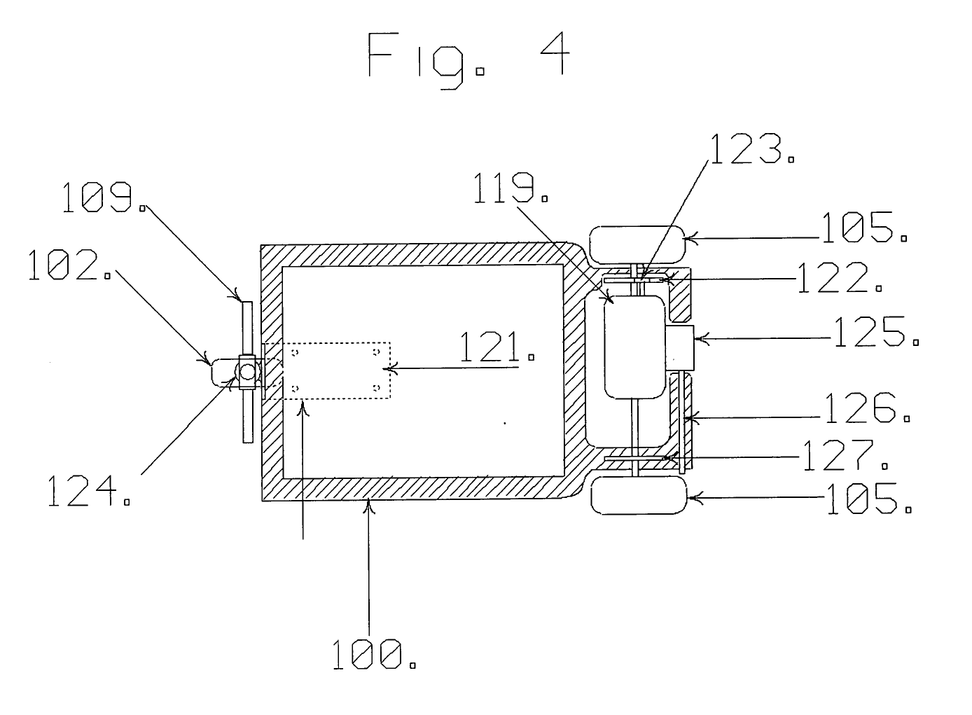

FIG. 3 shows the electric-powered embodiment of device 10, whereby an electric motor 120 is powered by battery 119. And, from FIG. 3 & FIG. 4, motor 120 drives sprocket 123, which in turn drives chain 106 to rear sprocket 122, which turns tire 105.

FIG. 4 shows where the front steering mechanism is shown to be attached at collar 124. In the preferred embodiment, such attachment is achieved through welding or other similar attachment means to plate 121. Plate 121 is attached to receptacle 100 through screws or some other suitable attachment means, and is also internally made into body 100. Steering of device 10 is made by turning handle 109 whose shaft 101 runs through a typical bearing collar 124 to make turning permissible.

FIG. 4 shows intake port and exhaust port 126 for motor 125, which allows air to enter the motor from behind and allows the exhaust to exit the motor through tube 126. There is an additional optional brake plate 127 shown so that in the event it is not feasible to apply a caliper to drive sprocket 122 there are optional braking means. The motor drive sprocket 123 is also shown.

In FIG. 5 a cross sectional view of device 10 is shown depicting the separation of motor compartment 148 from receptacle storage area 129 by barrier or division wall 130. The fuel tank 128 and rear brake caliper 115 are also shown.

FIG. 6 shows an alternative steering mechanism where the standard mechanical means for most typical wagons is used. This configuration is comprised of a turning platform 131 which is attached to axle 150 and whose assembly pivots upon spindle 133. Turning of platform 131 is accomplished by the turning of the handle 109, whose shaft 101 transfers the turning to the platform 131. Both brake levers 111 and 117 are also shown.

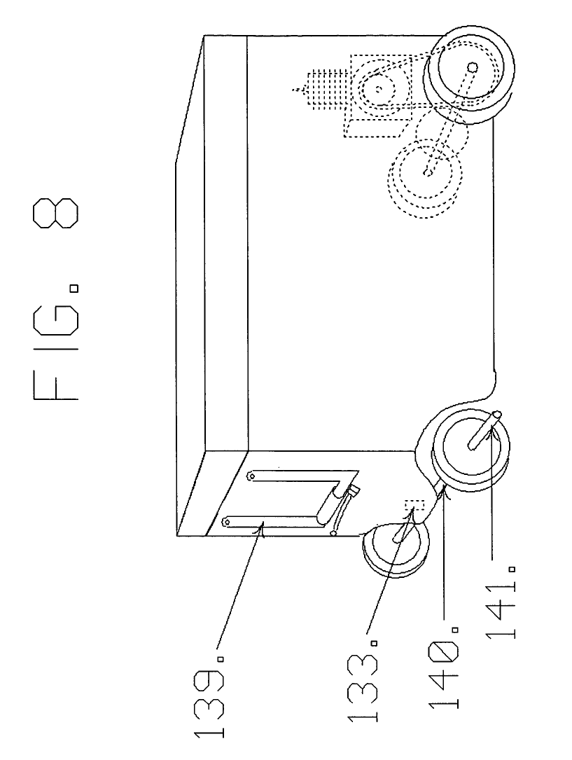

In FIG. 7 another alternative turning method is shown whereby a standard automotive type of steering application is utilized. In this embodiment, steering is accomplished by the turning of handle 109 which turns shaft 138 which transfers the turning force to pivot 135. The pivots on each respective wheel 136 are thereby turned by the tie rods 137 and wheel 102 turning is accomplished.

In FIG. 8 yet another turning method is accomplished by the simple pushing of the extended axle 141 by a drivers feet. The turning is provided, as differential pressure is applied to outer axle segment 141 by the driver and inner axle segment 140 turns upon pivot 133. This design also incorporates a simple handle design outfitted with the throttle and braking lever.

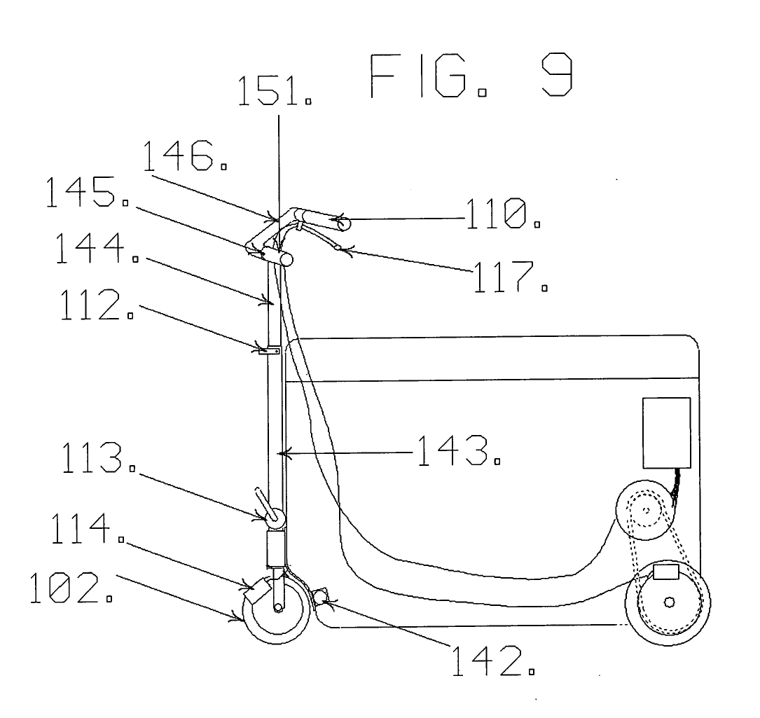

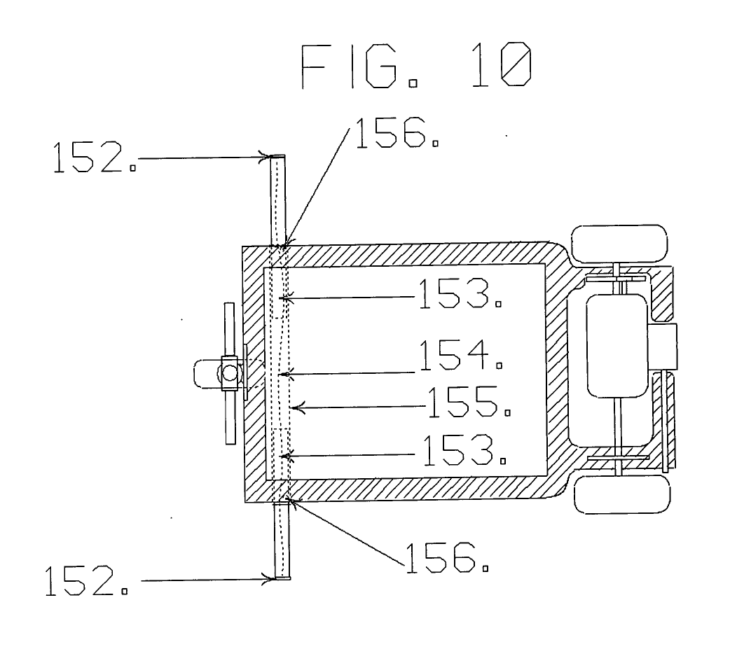

In FIG. 9 a more detailed, more complex steering application, used where lower steering tube shaft 143 is larger than the upper steering shaft 144 so that by loosening clamp 112 the steering tube can collapse into itself. This allows an operator to move the handle out of the way. The shaft assembly 144 and 112 can also be pivoted from its perpendicular position by the loosening of pivot clamp 113 and then the re-tightening of said clamp once the desired position is achieved. This design also incorporates a pivoting upper arm assembly 146 whose position can be changed by the suppression of a spring-loaded pin 145 whose new position is regulated by fixed holes in collar 151.

This configuration also uses a single brake level 117 and a single twisting throttle assembly 110, fixed upon shaft 146. This configuration allows the operator the ability to use this extended handle 146 to pull the invention if so desired. Also shown is the collapsible foot peg 142 which is a tube inside of another tube to allow extension.

In FIG. 10 a detailed view of the foot peg assembly is shown where each of the two-foot pegs 152 can be retracted into shaft 155 by the suppression of spring pin 156. The foot pegs 152 are spring loaded by the insertion of a elastic cord attached to each of the two pegs 152 which allows them to retract automatically once pin 156 is suppressed. It is also an alternate design of the invention to allow the foot pegs 152 to be folded up through a pivot point located approximately where pin 156 is located so that they are out of the way.

I claim:

1. A self propelled food and beverage receptacle, comprising:
An insulated storage means, configured to allow easy access to a storage compartment, and to provide adequate support for carry cargo, and for attachment to a motor means in a stable manner,
a motor means, attached to said insulated storage means and configured to provide adequate propulsion for said storage means,
a breaking means so situated to provide adequate speed reduction of said storage means,
a steering means in combination with said breaking means,
and at least one wheel in combination with said steering means and said breaking means.

2. The self propelled food and beverage receptacle of claim 1, further comprising at least one foot peg, configured to provide sufficient support for a rider upon said receptacle.

3. The self propelled food and beverage receptacle of claim 1, where said motor means is gasoline powered.

4. The self propelled food and beverage receptacle of claim 1, where said motor means is electric powered.

5. The self propelled food and beverage receptacle of claim 1, where said storage means is further configured to provide adequate support to a driver of said receptacle.

6. The self propelled food and beverage receptacle of claim 1, further comprising a throttle mechanism configured to provide differential speed of said receptacle.

7. The self propelled food and beverage receptacle of claim 1, where said steering means may be collapsed or angled for ease of driving or towing.

8. The self propelled food and beverage receptacle of claim 1, further comprising an attachment means whereby said receptacle may be reversibly attaché to a towed and/or towing vehicle.
